(19) United States
(12) Patent Application Publication
(10) Pub. No.: US 2025/0243909 A1
(43) Pub. Date: Jul. 31, 2025

(54) TRIPOD-TYPE CONSTANT-VELOCITY UNIVERSAL JOINT

(71) Applicant: NTN CORPORATION, Osaka (JP)

(72) Inventors: Shota KAWATA, Shizuoka (JP); Jungmu YANG, Shizuoka (JP); Hideto FUJIWARA, Shizuoka (JP); Kazuya USHIO, Shizuoka (JP); Sho TAKESHITA, Shizuoka (JP); Tsubasa NISHIKAWA, Shizuoka (JP)

(21) Appl. No.: 18/857,930

(22) PCT Filed: Apr. 12, 2023
(86) PCT No.: PCT/JP2023/014824

§ 371 Date: Oct. 18, 2024

(30) Foreign Application Priority Data
Apr. 27, 2022 (JP) 2022-073074

(51) Int. Cl. F16D 3/205; F16D 3/202

(52) U.S. Cl. CPC F16D 3/2055; F16D 2003/2026

(57) ABSTRACT

In a state where a joint forms a normal operating angle and an axial line of an inner ring is not tilted with respect to an axial line of a leg shaft, when a curvature radius and a minor axis/major axis ratio at which a contact area between an inner ring inner peripheral surface and a leg shaft outer peripheral surface is minimized are set as respective reference values, the minor axis/major axis ratio is set to the reference value, and the curvature radius is set to be smaller than the reference value. In addition, a carbon content in a core portion of a tripod member is set to 0.23 to 0.44%, and a hardened layer is formed through carburizing and quenching on a surface of each leg shaft.

### TECHNICAL FIELD

The present invention relates to a tripod type constant velocity universal joint used for power transmission.

### BACKGROUND ART

In a drive shaft used in a power transmission system of an automobile, it is often the case that a plunging type constant velocity universal joint is coupled to an inboard side (center side in a vehicle width direction) of an intermediate shaft, and that a fixed type constant velocity universal joint is coupled to an outboard side (end side in the vehicle width direction) thereof. The plunging type constant velocity universal joint described here allows both angular displacement and axial relative movement between two axes, and the fixed type constant velocity universal joint allows angular displacement between the two axes but does not allow axial relative movement between the two axes.

As the plunging type constant velocity universal joint, a tripod type constant velocity universal joint is known. For the tripod type constant velocity universal joint, there are a single-roller type and a double-roller type. In the single-roller type, a roller inserted into a track groove of an outer joint member is rotatably attached to a leg shaft of a tripod member via a plurality of needle rollers. The double-roller type includes a roller inserted into a track groove of an outer joint member, and an inner ring fitted onto a leg shaft of a tripod member to rotatably support the roller. The double-roller type enables the roller to swing with respect to the leg shaft, and thus has an advantage that induced thrust (axial force induced by friction between components inside the joint) and slide resistance can be reduced as compared with the single-roller type. Patent Literature 1 described below discloses an example of a tripod type constant velocity universal joint of a double-roller type.

In the tripod type constant velocity universal joint of the double-roller type in Patent Literature 1, an outer peripheral surface of a leg shaft is formed in a straight shape parallel to the axial line of the leg shaft, in a longitudinal section. In a transverse section, the outer peripheral surface of the leg shaft forms an elliptical sectional shape whose major axis is orthogonal to the axial line of the joint. An inner peripheral surface of an inner ring has an arc-shaped convex section in which a generatrix is formed of a convex arc having a radius r. The outer peripheral surface of the leg shaft and the inner peripheral surface of the inner ring are brought into contact with each other in a region close to a point in a direction orthogonal to the axial line of the joint, and a clearance is formed between the outer peripheral surface of the leg shaft and the inner peripheral surface of the inner ring in the axial-line direction of the joint, whereby a roller unit including a roller, the inner ring, and needle rollers can swing with respect to the axial line of the leg shaft.

### CITATION LIST

### Patent Literature

Patent Literature 1: JP 3599618 B2

### SUMMARY OF INVENTION

### Technical Problem

Patent Literature 1 (paragraph 0031) describes that the ring is not tilted even when the joint forms a maximum operating angle and that a surface pressure between the leg shaft and the ring can be minimized by setting a minor axis/major axis ratio b/a, where a is a major axis radius and b is a minor axis radius of the elliptical section of the leg shaft, and a curvature radius r of the inner peripheral surface of the inner ring as b/a=0.759 and the curvature radius r=1.369 a, respectively.

As in Patent Literature 1, in the case where the value of r and the minor axis/major axis ratio b/a are determined so as to minimize a contact surface pressure, the roller unit is not tilted with respect to a roller guide surface of an outer joint member up to a predetermined operating angle, and thus the induced thrust and the slide resistance can be reduced to low levels. However, when the operating angle exceeds the predetermined operating angle, the roller unit is tilted with respect to the roller guide surface, which leads to an increase in the induced slide and the slide resistance to cause a problem.

In particular, it has been found that this problem more conspicuously arises when torque applied to the tripod type constant velocity universal joint increases or when the tripod type constant velocity universal joint is used for a long period of time.

Therefore, it is an object of the present invention to reduce vibration of a tripod type constant velocity universal joint of a double-roller type.

### Solutions to Problem

In order to achieve the above object, a tripod type constant velocity universal joint according to the present invention includes: an outer joint member including track grooves extending in a joint axial direction at three locations in a circumferential direction, each of the track grooves having a pair of roller guide surfaces arranged to face each other in a joint circumferential direction; a tripod member including three leg shafts protruding in a radial direction; rollers each mounted to a corresponding one of the leg shafts; and inner rings each fitted onto a corresponding one of the leg shafts and rotatably supporting a corresponding one of the rollers.

In the tripod type constant velocity universal joint, the rollers are movable in an axial direction of the outer joint member along the roller guide surfaces. In addition, the inner ring includes an inner peripheral surface whose generatrix is formed in a shape of an arc that is convex. The leg shaft includes an outer peripheral surface having a straight shape in a longitudinal section. The outer peripheral surface of the leg shaft is in contact with the inner peripheral surface of the inner ring in a direction orthogonal to a joint axial line, in a transverse section. Further, the outer peripheral surface of the leg shaft forms a clearance with the inner peripheral surface of the inner ring in a joint axial-line direction. The transverse section of the leg shaft has an elliptical shape in which a major axis radius is represented by a and a minor axis radius is represented by b.

In the tripod type constant velocity universal joint, a curvature radius of the are in a longitudinal section of the inner peripheral surface of the inner ring is represented by r, and a minor axis/major axis ratio is set as b/a. In a state where an axial line of the inner ring is not tilted with respect to an axial line of the leg shaft, when each of the curvature radius r and the minor axis/major axis ratio b/a at which a contact area between the inner peripheral surface of the inner ring and the outer peripheral surface of the leg shaft is minimized is set as a reference value, the minor axis/major axis ratio b/a is set to the reference value, and the curvature radius r is set to be smaller than the reference value.

Further, in the tripod type constant velocity universal joint, a carbon content in a core portion of the tripod member is 0.23 to 0.44%. A hardened layer is formed through carburizing and quenching on a surface of the leg shaft of the tripod member. Ts torque is set as torque that is 0.3 times minimum static torsional torque at which a torsional fracture occurs in a shaft connected to the tripod member, and an effective hardened layer depth, with limit hardness of 600 HV, of the hardened layer is equal to or greater than a shear stress depth exhibited when the Ts torque is applied.

In the case of the tripod type constant velocity universal joint described above, a low vibration region can be expanded to a large operating angle even after long-term use of the joint, and deterioration of vibration characteristics over time can be avoided.

The value of r is preferably 1.4 a or more and 2.5 a or less.

In addition, the minor axis/major axis ratio b/a is preferably 0.8 or more and 0.9 or less.

The tripod type constant velocity universal joint described above particularly meets a condition under which torque of 1000 Nm or more is applied.

### Advantageous Effect of Invention

According to the present invention, it is possible to reduce vibration of a tripod type constant velocity universal joint of a double-roller type.

### BRIEF DESCRIPTION OF DRAWINGS

FIG. 1 is a cross-sectional view illustrating a tripod type constant velocity universal joint of a double-roller type, the view being taken along a joint axial direction.

FIG. 2 is a cross-sectional view as viewed in a direction indicated by the arrows of line K-K in FIG. 1.

FIG. 3 is a cross-sectional view taken along line L-L in FIG. 1.

FIG. 4 is a cross-sectional view illustrating a state in which the tripod type constant velocity universal joint of FIG. 1 forms an operating angle.

FIG. 5 is a cross-sectional view illustrating a hardened layer formed on a tripod member.

FIG. 6 is a side view conceptually illustrating a contact ellipse formed at a contact portion between a leg shaft and an inner ring.

FIG. 7 is a side view conceptually illustrating change in the contact ellipse formed at the contact portion between the leg shaft and the inner ring.

FIG. 8 is a graph illustrating an experimental result on induced thrust.

FIG. 9 is a diagram for explaining surface pressure distribution of the contact ellipse and change in shear stress in a depth direction.

FIG. 10 is a graph illustrating hardness distribution of a conventional product.

FIG. 11 is a graph illustrating hardness distribution of an example product.

FIG. 12 is a table illustrating measurement results on induced thrust after durability tests, for Comparative Examples and an Example.

### DESCRIPTION OF EMBODIMENT

An embodiment of a tripod type constant velocity universal joint according to the present invention will be described with reference to FIGS. 1 to 12.

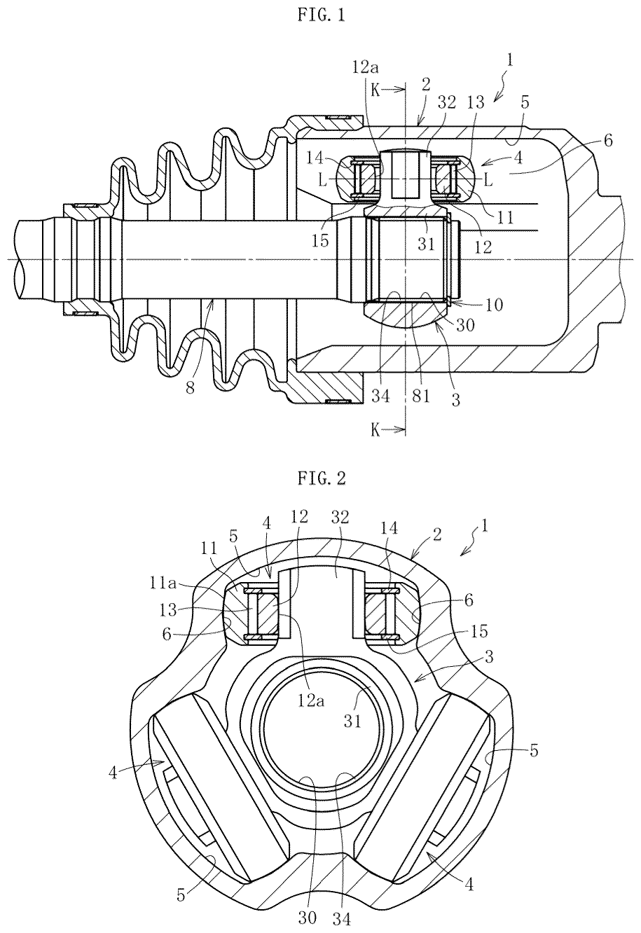

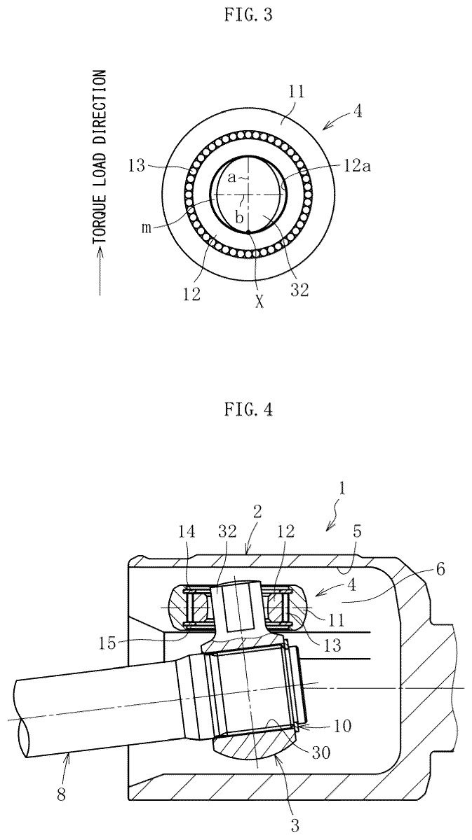

The tripod type constant velocity universal joint 1 of the present embodiment illustrated in FIGS. 1 to 4 is a double-roller type. FIG. 1 is a cross-sectional view of the tripod type constant velocity universal joint of the double-roller type, the view being taken along an axial direction thereof. FIG. 2 is a cross-sectional view as viewed in a direction indicated by the arrows of line K-K in FIG. 1. FIG. 3 is a cross-sectional view taken along line L-L in FIG. 1. FIG. 4 is a cross-sectional view illustrating the tripod type constant velocity universal joint when an operating angle is formed, the view being taken along the axial direction. Note that in the following description, the joint axial direction means an axial direction of the tripod type constant velocity universal joint when the operating angle thereof is brought into a state of 0°.

As illustrated in FIGS. 1 and 2, the tripod type constant velocity universal joint 1 includes, as main components thereof, an outer joint member 2, a tripod member 3 serving as an inner joint member, and roller units 4 serving as torque transmitting members. The outer joint member 2 has a cup shape with one end thereof opened, and is formed with three linear track grooves 5 extending in the joint axial direction on the inner peripheral surface of the outer joint member 2 at equal intervals in a joint circumferential direction. In each of the track grooves 5, roller guide surfaces 6 are formed, which are arranged to face each other in the joint circumferential direction of the outer joint member 2, and which extend in the joint axial direction. The tripod member 3 and the roller units 4 are placed inside the outer joint member 2.

The tripod member 3 integrally includes a barrel 31 (trunnion barrel) having a center hole 30, and three leg shafts 32 (trunnion journals) protruding in a radial direction from trisected positions in the joint circumferential direction of the outer peripheral surface of the barrel 31. The tripod member 3 is coupled to a shaft 8 serving as a shaft in a torque transmittable manner by fitting a male spline 81 formed on the shaft 8 into a female spline 34 formed in the center hole 30 of the trunnion barrel 31. The tripod member 3 is fixed to the shaft 8 in the joint axial direction by causing an end surface of the tripod member 3 on one side in the joint axial direction to engage with a shoulder portion provided on the shaft 8 while causing a retaining ring 10 mounted on a tip end of the shaft 8 to engage with an end surface of the tripod member 3 on the other side in the joint axial direction.

The roller unit 4 includes, as main components thereof, an outer ring 11 that is an annular roller centered on the axial line of the leg shaft 32, an annular inner ring 12 disposed on the radially inner side of the outer ring 11 and fitted onto the leg shaft 32, and a large number of needle rollers 13 interposed between the outer ring 11 and the inner ring 12. The roller unit 4 is received in the track groove 5 of the outer joint member 2. The roller unit 4 including the outer ring 11, the inner ring 12, and the needle rollers 13 has an inseparable structure with washers 14, 15.

In this embodiment, an outer peripheral surface 11a (see FIG. 2) of the outer ring 11 is a convex curved surface whose generatrix is an are having a center of curvature on the axial line of the leg shaft 32. The outer peripheral surface 11a of the outer ring 11 is in angular contact with the roller guide surfaces 6.

The needle rollers 13 are arranged to be rollable between an outer raceway surface and an inner raceway surface while using a cylindrical inner peripheral surface of the outer ring 11 as the outer raceway surface and a cylindrical outer peripheral surface of the inner ring 12 as the inner raceway surface.

An outer peripheral surface of each of the leg shafts 32 of the tripod member 3 has a straight shape in the axial direction of the leg shaft 32 in a cross section (longitudinal section) in any direction including the axial line of the leg shaft 32. In addition, as illustrated in FIG. 3, the outer peripheral surface of the leg shaft 32 forms an elliptical shape (including the case in which the outer peripheral surface forms a substantially elliptical shape) in a cross section (transverse section) orthogonal to the axial line of the leg shaft 32. The outer peripheral surface of the leg shaft 32 is in contact with an inner peripheral surface 12a of the inner ring 12 in a direction orthogonal to the joint axial direction, that is, in the direction of a major axis a. In the joint axial direction, that is, in the direction of a minor axis b, a clearance m is formed between the outer peripheral surface of the leg shaft 32 and the inner peripheral surface 12a of the inner ring 12.

The inner peripheral surface 12a of the inner ring 12 has a convex arc shape in any cross section including the axial line of the inner ring 12. From this fact and the fact that a shape in the transverse section of the leg shaft 32 is elliptical as described above and the predetermined clearance m is formed between the leg shaft 32 and the inner ring 12, the inner ring 12 can swing with respect to the leg shaft 32. Since the inner ring 12 and the outer ring 11 are assembled to be rotatable relative to each other via the needle rollers 13 as described above, the outer ring 11, together with the inner ring 12, can swing with respect to the leg shaft 32. That is, in a plane including the axial line of the leg shaft 32, the axial lines of the outer ring 11 and the inner ring 12 can tilt with respect to the axial line of the leg shaft 32 (see FIG. 4).

As illustrated in FIG. 4, when the tripod type constant velocity universal joint 1 rotates at an operating angle, the axial line of the tripod member 3 is tilted with respect to the axial line of the outer joint member 2. However, the roller unit 4 can swing, and thus it is possible to avoid a state in which the outer ring 11 and the roller guide surface 6 obliquely intersect with each other. As a result, the outer ring 11 rolls horizontally with respect to the roller guide surface 6, and thus induced thrust and slide resistance can be reduced, and vibration of the tripod type constant velocity universal joint 1 can be reduced.

In addition, as described above, the transverse section of the leg shaft 32 is elliptical and the longitudinal section of the inner peripheral surface 12a of the inner ring 12 is an arc-shaped convex section. Thus, as illustrated in FIG. 3, the outer peripheral surface of the leg shaft 32 and the inner peripheral surface 12a of the inner ring 12 on a torque load side come into point contact with each other, or come into contact with each other in a small area approximate to an area of point contact, in a region X on the major axis a. Therefore, a force attempting to cause the roller unit 4 to tilt is reduced, and the stability of the posture of the outer ring 11 is improved.

The tripod member 3 described above is manufactured from a steel material through main processes of a forging process (cold forging process)→a machining (turning) process→a broaching process of the spline 34→heat treatment→a grinding process of the outer peripheral surface of the leg shaft 32. The outer peripheral surface of the leg shaft 32 can be finished by hardened steel cutting instead of the grinding process. In addition, before the cold forging, a spheroidizing annealing process and a bonderizing treatment process can be added. The spheroidizing annealing process can be omitted for circumstances such as use of a material having a low carbon content if no problem occurs in forging properties at the time of cold forging. As the heat treatment, carburizing, quenching, and tempering are performed.

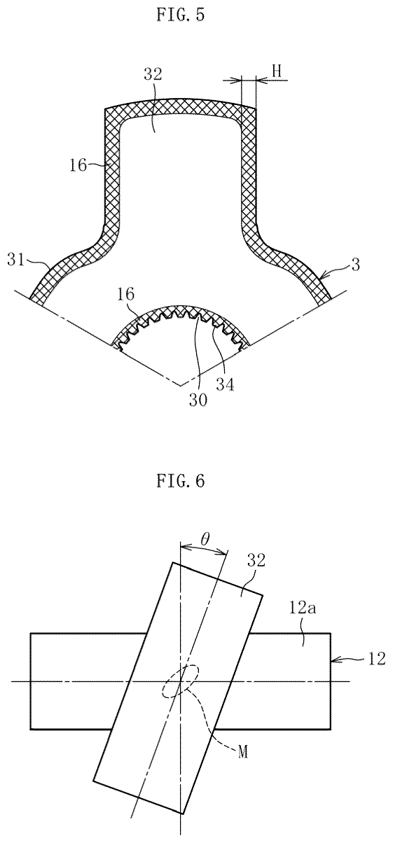

FIG. 5 is a cross-sectional view illustrating a hardened layer 16 formed through heat treatment on the tripod member 3. The hardened layer 16 is formed by hardening a carburized layer through quenching. The hardened layer 16 is formed on the entire surface of the tripod member 3 including the outer peripheral surface of the leg shaft 32, the outer peripheral surface of the barrel 31, and the surface of the female spline 34. In the tripod member 3 as a finished product, the outer peripheral surface of the leg shaft 32 is finished by grinding (or hardened steel cutting), and thus a depth of the hardened layer 16 on the outer peripheral surface of the leg shaft 32 is shallower than that in other regions by an allowance for grinding or the like. Note that since this allowance is usually as small as about 0.1 mm, the thickness of the hardened layer 16 is uniformly drawn on the entire surface in FIG. 5.

In the tripod type constant velocity universal joint of the double-roller type described above, the outer peripheral surface of the leg shaft 32 and the inner peripheral surface 12a of the inner ring 12 come into point contact with each other, or come into approximately point contact with each other, in the region X on the torque load side, as illustrated in FIG. 3. At this time, a contact ellipse is formed at the contact point X. It is known that the area and shape of the contact ellipse are deeply related to induced thrust and slide resistance of the joint.

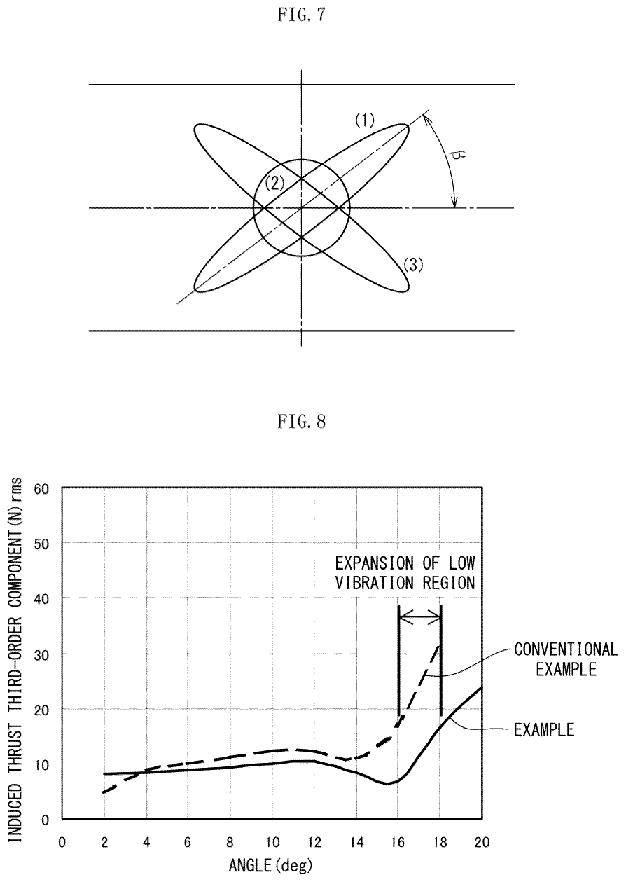

The shape of the contact ellipse can be defined by a minor axis/major axis ratio b/a of an elliptical section of the leg shaft 32 and a curvature radius r of an are-shaped convex R in the longitudinal section of the inner peripheral surface of the inner ring 12. Regarding this relationship, the following facts have been found so far.
(A) When the tripod type constant velocity universal joint of the double-roller type transmits torque while forming an operating angle θ, a contact ellipse M between the leg shaft 32 and the inner ring 12 illustrated in FIG. 6 changes, during one rotation of the joint, as follows: (1)→(2)→(3)→(2)→(1), as illustrated in FIG. 7. When the operating angle θ is small, the contact ellipse M becomes close to a circular shape, and thus a moment attempting to cause the inner ring 12 to tilt also becomes small. On the other hand, when the operating angle θ increases, the contact ellipse is laterally elongated toward a circumferential direction, and the moment attempting to cause the inner ring to tilt increases.
(B) In a state where the axial line of the inner ring 12 is not tilted with respect to the axial line of the leg shaft 32, the shape of a contact ellipse in which a contact area between the inner peripheral surface 12a of the inner ring 12 and the outer peripheral surface of the leg shaft 32 is minimized is circular. When the inner ring 12 is tilted with respect to the leg shaft 32 from this state, the shape of the contact ellipse changes to a laterally elongated elliptical shape.
(C) A major axis length of the contact ellipse at the contact portion X between the inner peripheral surface 12a of the inner ring 12 and the outer peripheral surface of the leg shaft 32 is the shortest when the inner ring 12 is not tilted with respect to the leg shaft 32, and becomes longer as the tilt of the inner ring 12 with respect to the leg shaft 32 increases. Thus, even when the curvature radius r of the inner ring inner peripheral surface 12a and the minor axis/major axis ratio b/a are constant values, the size of the contact area changes depending on the degree of the tilt between the inner ring 12 and the leg shaft 32. Specifically, the contact area is the smallest when the inner ring 12 is not tilted with respect to the leg shaft 32 (operating angle=0°), and the contact area increases as the tilt of the inner ring 12 with respect to the leg shaft 32 increases (operating angle>0°).

On the basis of the above findings, in a conventional tripod type constant velocity universal joint of a double-roller type, in a state where the axial line of the inner ring 12 is not tilted with respect to the axial line of the axial line of the leg shaft 32 (a state where the operating angle is 0°), the curvature radius r and the minor axis/major axis ratio b/a are set such that a contact area between the inner peripheral surface of the inner ring and the outer peripheral surface of the leg shaft is minimized (at this time, the contact ellipse is circular).

At the curvature radius r and the minor axis/major axis ratio b/a at which the contact area is minimized in this manner, the roller assembly 4 is not tilted with respect to the roller guide surface 6 of the outer joint member 2 up to a predetermined operating angle. Thus, induced thrust and slide resistance can be reduced to low levels. However, when the operating angle exceeds the predetermined operating angle, the roller assembly 4 starts to tilt with respect to the roller guide surface 6 due to interference of the contact ellipse, which leads to an increase in the induced thrust and the slide resistance.

On the other hand, in the present embodiment, in a state where the axial line of the inner ring is not tilted with respect to the axial line of the leg shaft 32, when a curvature radius r and a minor axis/major axis ratio b/a at which the contact area between the inner peripheral surface 12a of the inner ring 12 and the outer peripheral surface of the leg shaft 32 is minimized are set as respective reference values, the reference value is adopted for the minor axis/major axis ratio b/a, and the curvature radius r is set to be smaller than the reference value thereof.

By setting the minor axis/major axis ratio b/a to the reference value thereof and setting the curvature radius r to be smaller than the reference value thereof in this manner, the lengths of the major axis and minor axis of the contact ellipse become smaller (operating angle θ>0), and a contact ellipse angle β becomes smaller, as compared with the case of adopting the curvature radius r and the minor axis/major axis ratio b/a at which the contact area is minimized. Thus, the moment attempting to cause the inner ring 12 to tilt is reduced, and the induced thrust can be reduced.

Note that the curvature radius r is preferably in the range of 1.4 a to 2.5 a. In addition, the minor axis/major axis ratio b/a is preferably in the range of 0.8 to 0.9.

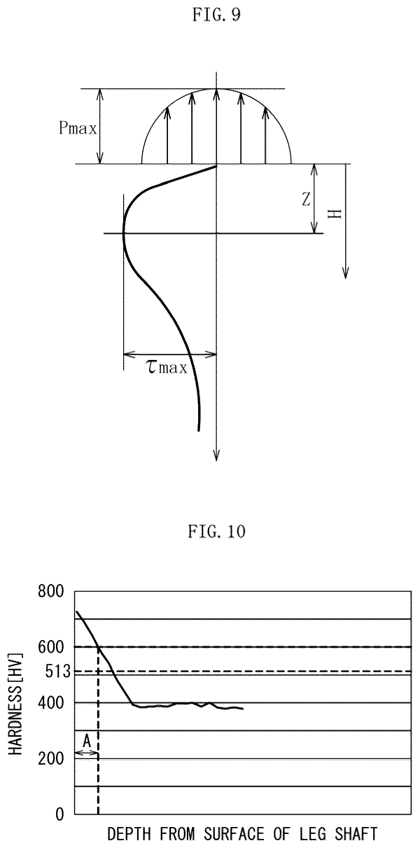

FIG. 8 illustrates an experimental result on an induced thrust third-order component when the operating angle is changed. When the permissible upper limit of the induced thrust component is 20 N, it can be understood that a low vibration region of the tripod type constant velocity universal joint can be expanded to a larger angle side as illustrated in FIG. 9. Note that the “Conventional Example” in FIG. 8 means an example in which both the curvature radius r and the minor axis/major axis ratio b/a are set to the respective reference values. In addition, the “Example” means an example in which the minor axis/major axis ratio b/a is set to the reference value and the curvature radius r is set to be smaller than the reference value.

However, even if such a configuration is adopted, when the tripod type constant velocity universal joint is used for a long period of time, the durability of the leg shaft 32 was found to be reduced at the contact portion X, and thus it was found that vibration characteristics are deteriorated over time. This tendency is particularly conspicuous when the tripod type constant velocity universal joint is used under a condition that high torque (1000 Nm or more) is frequently applied thereto.

In order to cope with this problem, it was conceived that a hardened layer having high hardness is formed deep to improve the durability of the leg shaft 32, in the present embodiment. On the basis of this idea, for the material of the tripod member 3, carbon content in a steel material is increased as compared with the steel material conventionally used, and an effective hardened layer depth of the hardened layer is set to a depth corresponding to torque applied to the tripod type constant velocity universal joint. Each will be described below.
(1) Increase in Carbon Content

For a conventional tripod member 3, chromium-molybdenum steel, which is a kind of case-hardening steel, is often used as a material thereof. In the present embodiment, a steel material having a carbon content of more than 0.23% (a steel material having a carbon content of preferably 0.24% or more, more preferably 0.32% or more) is used as the material (“%” representing the carbon content means “mass %”) However, if the carbon content is too high, formability at the time of forging the tripod member is reduced, and thus a steel material having a carbon content of 0.44% or less is used. An example of the case-hardening steel satisfying this condition can be chromium-molybdenum steel SCM435 or SCM440 specified in JIS G 4053. In addition, it is preferable to use, as the steel material, so-called H steel (SCM435H, SCM440H) that is specified in JIS G 4052 and whose hardenability is guaranteed. Incidentally, according to JIS G 4052, the carbon content of SCM435H is 0.32% to 0.39%, and the carbon content of SCM440 is 0.37% to 0.44%.

Note that another type of steel material, for example, chromium steel (SCr435, SCr440, or the like) specified in JIS G 4053, can also be used as long as the steel is case-hardening steel satisfying the carbon content (0.23% or more and 0.44% or less) described above. For chromium steel, it is preferable to use H steel such as SCr435H or SCr440H in a manner similar to that in the above description. Incidentally, the carbon content of SCr435H is 0.32% to 0.39%, and the carbon content of SCr440H is 0.37% to 0.44%.

Note that on the surface of the tripod member 3, the carbon content is increased as compared with the carbon content in the material, due to carburizing and quenching. However, in a core portion of the tripod member 3, the carbon content (0.23% or more and 0.44% or less) of the material of the tripod member 3 is maintained even after carburizing and quenching.
(2) Setting of Effective Hardened Layer Depth

Further, in the present embodiment, an effective hardened layer depth H (limit hardness: 600 HV) of the hardened layer 16 formed on the surface of the tripod member 3 is set to be equal to or greater than a maximum shear stress depth Z exhibited when Ts torque is applied to the tripod type constant velocity universal joint 1 (H≥Z).

The “Ts torque” as used herein is a value that is 0.3 times the minimum static torsional torque at which a torsional fracture occurs in the shaft & connected to the tripod member 3. When the Ts torque is applied to the tripod type constant velocity universal joint 1, the contact ellipse is generated on the outer peripheral surface of the leg shaft 7 forming the contact portion X (see FIG. 3) on the load side with the inner peripheral surface 12a of the inner ring 12. At this time, as illustrated in FIG. 9, the center of the contact ellipse exhibits a maximum surface pressure Pmax. The depth at which a maximum shear stress τₘₐₓ is generated in a direction immediately below the leg shaft (a direction toward the radially inner side of the leg shaft 32) on the center of this contact ellipse is the “maximum shear stress depth Z”.

Note that the effective hardened layer depth means a distance from the surface of the steel material to a position of the limit hardness. According to JIS G 0557, the limit hardness of the effective hardened layer is 550 HV, but it is also specified that “when the hardness at a position at a distance three times the distance of the hardened layer from the surface exceeds the Vickers hardness of 450 HV, the limit hardness exceeding 550 HV may be used through agreement between the parties”. In the present embodiment, as will be described later, an internal hardness of the tripod member 3 (the hardness of a non-quenched region) is 513 HV or more. Thus, by using the exception described above, in the present embodiment, the limit hardness of the effective hardened layer depth is defined as 600 HV. Note that since it is preferable to increase the hardness of the hardened layer 16 as much as possible from the viewpoint of the durability of the leg shaft 7, it is preferable to define the limit hardness of the effective hardened layer depth to be 653 HV or more.

By increasing the internal hardness after carburizing, quenching, and tempering, it is possible to increase the effective hardened layer depth. By causing the internal hardness to be 513 HV or more, it is possible to obtain the effective hardened layer depth (limit hardness: 600 HV) equal to or greater than the maximum shear stress depth as described above.

Note that the surface hardness of the leg shaft 7 is preferably 653 HV or more, in order to reduce wear due to rolling of the mating component (the inner ring 12 in the present embodiment) of the leg shaft.

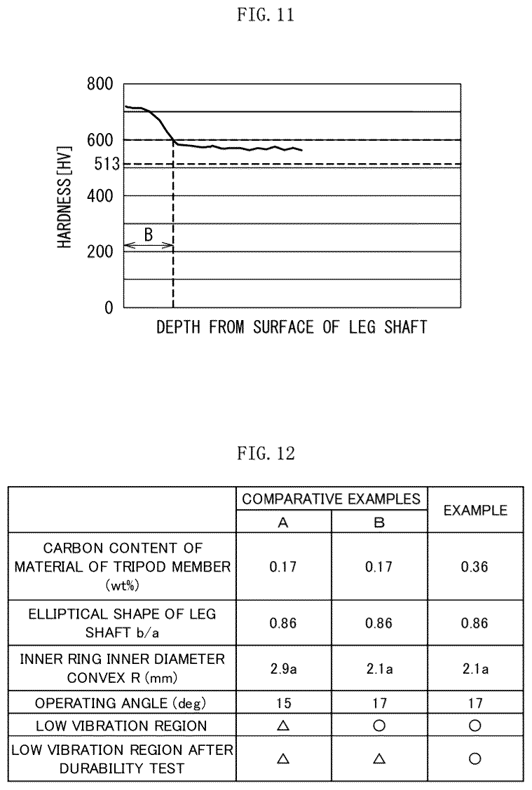

FIGS. 10 and 11 are diagrams each illustrating hardness distribution in a case where the horizontal axis shows a depth from the surface of the leg shaft. Note that the hardness was measured at the contact portion X of the outer peripheral surface of the leg shaft 32, at which the outer peripheral surface of the leg shaft 32 is in contact with the inner peripheral surface 12a of the inner ring 12. Of FIGS. 10 and 11, FIG. 10 illustrates the hardness distribution of a conventional product using a low-carbon steel (equivalent material having a carbon content equivalent to 0.17%), and FIG. 11 illustrates the hardness distribution of an example product using a high-carbon steel material (equivalent material having a carbon content equivalent to 0.34%). Respective effective hardened layer depths in a case where the limit hardness is defined as 600 HV are represented by “A” in FIG. 10 and “B” in FIG. 11. It was found that due to the difference in the carbon contents in this manner, a difference occurred in the effective hardened layer depths (A<B) even when carburizing, quenching, and tempering were performed under the same treatment conditions. Specifically, it was confirmed that the effective hardened layer depth was doubled (2.0 A) when the equivalent material having a carbon content equivalent to 0.34%, which has a higher carbon content, was used, and that the effective hardened layer depth was 2.5 times (2.5 A) greater when an equivalent material having a carbon content equivalent to 0.41%, which has a further higher carbon content, was used.

From the result illustrated in FIG. 11, the example product can prevent a reduction in hardness from the surface to the inside, and can maintain, even in the inside thereof, the hardness of 513 HV, which is a target characteristic. Thus, the effective hardened layer depth H of the hardened layer 16 can be set to be equal to or greater than the maximum shear stress depth Z exhibited when the Ts torque is applied to the tripod type constant velocity universal joint 1. Accordingly, in the tripod type constant velocity universal joint of the double-roller type in which the outer peripheral surface of the leg shaft 7 and the inner peripheral surface 12a of the inner ring 12 are in contact with each other in a region close to a point on the torque load side, the durability of the leg shaft can be improved. Therefore, it is possible to prevent an occurrence of a situation in which the movement of the roller unit 4 is hindered, and it is possible to prevent deterioration of vibration characteristics over time.

On the other hand, since the carbon content is limited to 0.44% or less, the forgeability of the tripod member 3 is not extremely deteriorated, and an increase in the forging cost of the tripod member 3 can be prevented.

Further, the maximum shear stress depth is determined on the basis of the concept of the Ts torque as in the present embodiment, whereby the effective hardened layer depth can be determined in a manner conforming to actual use conditions. Thus, regardless of the size of the tripod type constant velocity universal joint, the above operation and effects can be stably obtained.

FIG. 12 illustrates results obtained by measuring induced thrust third-order components after durability tests, for two types of Comparative Examples A, B and an Example. In Comparative Example A, the curvature radius r and the minor axis/major axis ratio b/a were set to values (reference values) at which the contact area at the contact portion X is minimized when the operating angle is 0°. In each of Comparative Example B and the Example, the minor axis/major axis ratio b/a was set to the reference value, and the curvature radius r was set to be smaller than the reference value. In each of Comparative Examples A, B. the carbon content of the material of the tripod member 3 (before carburizing and quenching) was 0.17%, and in the Example, the carbon content of the material of the tripod member 3 (before carburizing and quenching) was 0.36%. In addition, in the Example, the Ts torque was set as torque that is 0.3 times the minimum static torsional torque at which a torsional fracture occurs in the shaft connected to the tripod member 3, and the effective hardened layer depth, with limit hardness of 600 HV, of the hardened layer 16 was set to be equal to or greater than the shear stress depth exhibited when the Ts torque is applied. Note that the “low vibration region” in the table means a region of the operating angle in which the induced thrust third-order component is 50 N or less. This is based on the assumption that torque of 1000 Nm is applied to the tripod type constant velocity universal joint.

Note that the durability test was performed for each of the joints of Comparative Examples A, B and the Example under the conditions of an operating angle of 10°, torque of 1500 Nm, a rotation speed of 600 rpm, and an operation time of 40 h.

From the above test results, it was confirmed that a low vibration region of Comparative Example A remained within a smaller-operating-angle region whereas low vibration regions of Comparative Example B and the Example each expanded to a larger-operating-angle region (the second row from the bottom in FIG. 12). In addition, in Comparative Example B, it was found that a low vibration region after the durability test remained within smaller operating angles (operating angles of 0 to 11°), whereas in the Example, it was found that a low vibration region after the durability test expanded to larger operating angles (operating angles of 0 to 13°) (the lowermost row in FIG. 12). Therefore, it was found that in the tripod type constant velocity universal joint according to the present embodiment, the low vibration region can be expanded to a larger operating angle even after long-term use, and that deterioration of vibration characteristics over time can be avoided.

Although an embodiment of the present invention has been described above, as a matter of course, the present invention is not limited to the embodiment described above, and various modifications can be made without departing from the gist of the present invention. For example, the tripod type constant velocity universal joint according to the present invention can be used for a rear drive shaft as well as a front drive shaft of a vehicle.

### REFERENCE SIGNS LIST

1 Tripod type constant velocity universal joint
2 Outer joint member
3 Tripod member
4 Roller unit
5 Track groove
6 Roller guide surface
8 Shaft
11 Roller (outer ring)
12 Inner ring
13 Needle roller
16 Hardened layer
30 Center hole
31 Barrel
32 Leg shaft
34 Female spline

1. A tripod type constant velocity universal joint, comprising:
an outer joint member including track grooves extending in a joint axial direction at three locations in a circumferential direction, each of the track grooves having a pair of roller guide surfaces arranged to face each other in a joint circumferential direction;
a tripod member including three leg shafts protruding in a radial direction;
rollers each mounted to a corresponding one of the leg shafts; and
inner rings each fitted onto a corresponding one of the leg shafts and rotatably supporting a corresponding one of the rollers,
the rollers being movable in an axial direction of the outer joint member along the roller guide surfaces,
the inner ring including an inner peripheral surface whose generatrix is formed in a shape of an arc that is convex,
the leg shaft including an outer peripheral surface having a straight shape in a longitudinal section,
the outer peripheral surface of the leg shaft being in contact with the inner peripheral surface of the inner ring in a direction orthogonal to a joint axial line, in a transverse section,
the outer peripheral surface of the leg shaft forming a clearance with the inner peripheral surface of the inner ring in a joint axial-line direction,
the transverse section of the leg shaft having an elliptical shape in which a major axis radius is represented by a and a minor axis radius is represented by b,
wherein
a curvature radius of the arc in a longitudinal section of the inner peripheral surface of the inner ring is represented by r, and a minor axis/major axis ratio is set as b/a,
in a state where an axial line of the inner ring is not tilted with respect to an axial line of the leg shaft, when each of the curvature radius r and the minor axis/major axis ratio b/a at which a contact area between the inner peripheral surface of the inner ring and the outer peripheral surface of the leg shaft is minimized is set as a reference value, the minor axis/major axis ratio b/a is set to the reference value, and the curvature radius r is set to be smaller than the reference value,
a carbon content in a core portion of the tripod member is 0.23 to 0.44%,
a hardened layer is formed through carburizing and quenching on a surface of the leg shaft of the tripod member, and
Ts torque is set as torque that is 0.3 times minimum static torsional torque at which a torsional fracture occurs in a shaft connected to the tripod member, and an effective hardened layer depth, with limit hardness of 600 HV, of the hardened layer is equal to or greater than a shear stress depth exhibited when the Ts torque is applied.

2. The tripod type constant velocity universal joint according to claim 1, wherein the value of r is 1.4 a or more and 2.5 a or less.

3. The tripod type constant velocity universal joint according to claim 1, wherein the minor axis/major axis ratio b/a is 0.8 or more and 0.9 or less.

4. The tripod type constant velocity universal joint according to claim 1, wherein torque of 1000 Nm or more is applied to the tripod type constant velocity universal joint.
